(19) United States
(12) Patent Application Publication
(10) Pub. No.: US 2026/0212407 A1
(43) Pub. Date: Jul. 23, 2026

(54) COMPUTER ENABLED SYSTEM FOR OPTIMIZATION OF PROPERTY RENTAL AND SALE ADVERTISING

(71) Applicants: Chad Malone, Wasilla, AK (US); Colby Malone, Palmer, AK (US)

(72) Inventors: Chad Malone, Wasilla, AK (US); Colby Malone, Palmer, AK (US)

(21) Appl. No.: 19/457,853

(22) Filed: Jan. 23, 2026

Related U.S. Application Data
(60) Provisional application No. 63/748,612, filed on Jan. 23, 2025.

(51) Int. Cl. G06Q 30/0645; G06Q 30/0241

(52) U.S. Cl. CPC G06Q 30/0645; G06Q 30/0277

(57) ABSTRACT

A system for the generation of advertisement listings for properties employing software-generated write-ups for a property advertisement which include determined distinctive characteristics of the property found within images and photos thereof. The system automatically generates text and advertisements and an online reservation site which may also include reservations for local activities and attractions available during the reservation dates.

This application claims priority to U.S. Provisional Patent Application 63/748,612 filed on Jan. 23, 2025.

### BACKGROUND OF THE INVENTION

### 1. Field of the Invention

The invention herein disclosed relates generally to the field of real estate rentals and sales. More particularly, it relates to a system employing software running on a computer accessible over a network which operates to identify, determine, and to highlight distinctive aspects of individual properties, and to additionally provide users with localized venues and activities geographically proximate to the identified property.

### 2. Prior Art

### Background of the Invention

With the advent of the Internet and websites for virtually and product or service, reservations for travel and accommodations on arrival are provided by a number of web-based firms. For example, Airbnb is a website and app-based marketplace that operates to connect buyers or people looking for accommodations with sellers, such as people who want to rent out their homes or rental apartments, and the like. There are other property rental sites on the internet that provide buyers with searchable rental properties by geographic area and desired time slots.

Conventionally, such online property rental providers offer a variety of properties for short and long-term rentals, including. Such rentals can include a variety of property types such as Apartments, Houses, Vacation homes, Private rooms, Shared rooms, Hotel rooms, Treehouses, Tents, Igloos, and even Churches.

During a search by buyers or renters searching for such a rental property, the listings can be filtered by a number of criteria. Such criteria choices, for example, include pet-friendly properties, properties with pools, available property dates, and nightly or monthly rates.

A primary attractant for buyers or renters to such property rental sites is that the booked properties often offer residential-style amenities like kitchens, dining rooms, and laundry facilities, and can frequently be cheaper than hotels. Conventionally, the site provider listing the rental properties is paid a commission, which is a percentage of the total price of a booking.

The proper promotion, advertising, and marketing of properties or structures is essential in order to generate interest and attract potential clients or customers. However, conventional property websites and methods of listing often fail to highlight the unique selling points of individual properties effectively in a manner that will engage with prospective customers. This oversight frequently results in missed opportunities for property owners and managers to achieve maximized rentals during available rental periods.

With respect to the above, before explaining at least one preferred embodiment of the system herein for generating optimized property listings for rent or sale, it is to be understood that the system herein is not limited in its application to the details of employment and to the arrangement of the components or the steps set forth in the following description or illustrated in the drawings. The various software-enabled methods and steps of the herein disclosed property listing optimization system are capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other property listing optimization systems. It is important, therefore, that the embodiments, objects, and claims herein be regarded as including such equivalent construction and methodology insofar as they do not depart from the spirit and scope of the present invention.

### SUMMARY OF THE INVENTION

The disclosed system herein operates with a software-enabled method enabling a systematic approach to promote and market properties or structures. The system operates to enhance the listing and overall rental of listed properties by identifying the unique selling points or distinctive characteristics, or key features of each property, and operating to create compelling listings. With listings created to maximize customer viewing, the system then operates to publicize the listed property and then engage with prospective customers to successfully close deals.

The system further operates to help optimize all listings for customers by including options for enhancing the vacation or trip using prearranged local vendors of products and services, which would be of interest to the identified buyer or renter. In listing a property on the provided system, property owners and managers can maximize their chances of attracting potential customers and achieving successful transactions.

In a first step in the system, software operating to the task of identifying the distinctive characteristics, amenities, and features of the listed property or structure is employed during registration of the property by the owner or manager. Such unique selling points, for example, include but are not limited to the structure location, the design, the size, the type of property, or the number of seats, or the number of rooms, and other appealing features such as but not limited to being wheelchair accessible. By determining these key aspects, the advertising and marketing message included in the listing can be tailored to the target audience's preferences.

In a unique property determination process, the distinctive characteristics of the listing may also be determined using image review software running to the task of a machine learning model, which is initially configured, and on an ongoing basis is trained to analyze property images or photos and determine and extract identified distinctive features of each.

Such image recognition software identifies parts of an image to determine distinctive characteristics or key features therein by analyzing it as a grid of pixels, using machine learning to find patterns in shapes, colors, and textures. The image recognition software works by first training a deep learning model, often a convolutional neural network (CNN), on a massive dataset of identified unique images of distinctive characteristics. During this training, the image recognition software learns to identify features, from simple edges and colors to complex object parts, to discern if a key feature is present. After training, the model can identify and locate objects and distinct property characteristics in new, unseen images by comparing the discerned key features to those it learned during the training process.

To that end, software operates to the task of electronically scanning electronic images of the uploaded property photos using advanced image recognition techniques. The image review software may be trained to identify photographic distinctive features using a stored database of imagery of individual key features from properties in a compiled stored database of individual distinctive characteristics which may add newly recognized distinctive characteristics from newly listed properties to enhance the ability of the image review software to identify such key features in comparisons of new photos to stored images of distinct features for matches thereto.

The software running to the task of image recognition operates to individually identify the distinctive characteristics, such as property amenities, and features of each property, and to store them to a database of key features or distinctive characteristics associated with each respective property. Such distinctive characteristics or key features recognized by the image recognition software include for example but are not limited to architectural style, interior design elements, special amenities such as swimming pools, hot tubs, garden spaces and location-based attributes such as for example and in no way limiting proximity to landmarks and/or scenic views of landmarks or the surrounding area.

Thereafter, using the image recognition software operates to the task of discerning distinctive characteristics from the digital photos of each new property based on predefined categories for such distinctive characteristics, which are either predetermined and held in electronic memory or are from patterns for distinctive characteristics learned during training. In this key feature assessment, the image recognition software for discerning distinctive characteristics assesses factors such as the presence of luxury items within the property, unique architectural designs of the property, determined scenic views, accessibility features such as distance to surrounding venues or interest to visitors, and other such distinctive characteristics.

In another step in the system software operating to the task of ranking the identified distinctive characteristics in each property is employed. Such ranking may be based on the attractiveness and uniqueness of the identified distinctive characteristics, or using historical data, and/or user engagement metrics determined from earlier placed similar listings of value to buyers for each key feature. The software operating to rank the identified distinctive characteristics is applied to operate in a manner that prioritizes identified distinctive characteristics which are known to be more likely to attract potential customers, be they new customers or return customers for which the system has identified desired distinctive characteristics therefor.

Next, a listing is crafted by the listing host which emphasizes the identified unique, distinctive characteristics by ranking which of such are determined to cater to a target audience. This listing serves as a comprehensive representation to customers for the property or structure and distinctive characteristics thereof, and is thus designed to capture the attention and interest of potential customers seeking such.

In operation to help the host craft a respective listing for a prospective property, in addition to the software operating to review images for distinctive characteristics, the system may provide an interactive listing creation interface, which operates to help the host maximize the potential of the listing to attract customers for the property.

To that end, from the previously uploaded photos and information, and review thereof, the system employs listing creation software which presents identified unique points and known distinctive characteristics for such properties to the listing owner or agent through an interactive user interface. A graphic display checklist format may be provided by the software, which is depicted on a graphic interface of the host, which allows the host to view and select the identified distinctive characteristics they want to highlight in the listing, and/or to list distinctive characteristics that were not identified by the image review software analysis.

The listing generation software may also operate to provide automated suggestions to a property owner host, based on previously determined most impactful distinctive characteristics and unique selling points for inclusion, based on data analysis and research of market trends, and upon the scoring of each type of key feature. These suggestions during the listing generation may be accompanied by brief explanations and examples of each to aid the host, such as the owner or manager of the property being listed to understand their significance.

During the step of generating the listing, there may be provided some customization options to the host for the listing. In this listing customization step, hosts may edit the suggested unique key selling points previously provided. They may also be given the option to add their own descriptions, and to deselect features or key selling points they don't find relevant.

Thus, in this customization step, using graphic interfaces therefor communicated to the host, the system allows for easy customization to tailor the generated property listing to include distinctive characteristics identified by the software, identified by the host, and according to the preferences of the host and the likelihood of being favored by the identified target audience. During the listing generation, the system herein may include insights as to distinctive characteristics and as to other aspects of successful property listings garnered from market research and user behavior studies. This can be communicated to the host generating the listing to justify the selection by the system of certain features as unique selling points. It has been determined that the presentation of such research operates to help the host understand which distinctive characteristics have been determined to have the most impact on potential renters or buyers and why.

Once the host user has employed the presented graphic interface to form their property listing, the system may also employ software operating to provide a preview of the generated listing and the functionality thereof. In this step, a software-generated preview of the listing for a property authored by the user host may be visually previewed on their display screen. It will provide the host with a manner in which to view how the listing they have generated will appear to potential customers, thereby ensuring that the unique points included by the host or user in generating the listing are effectively highlighted and presented.

In an example of the infraction of the software-generated interface, and in no way to be considered limiting, in the first step, the system will provide a graphic interface to allow the owner, agent, or host to upload digital photos of the property.

Next, using software operating to the task, the system operates to analyze the uploaded photos and to identify unique features such as an ocean view, a modern kitchen, or a private pool, as well as other distinctive characteristics noted above.

In a subsequent step during listing generation, the identified distinctive characteristics may be listed in a drop-down or page menu with check boxes next to each to allow the user to choose which distinctive characteristics to include in the generated listing. The owner or user of the presented graphic interface may select the distinctive characteristics to include, they may view suggested inclusions and reasons therefrom, and they may then customize the included descriptions.

Once the above steps have been accomplished, the owner or host user may preview a graphic depiction of the final listing generated by the system pursuant to their choices to ensure it accurately represents the unique points and distinctive characteristics of the property according to their liking and professional judgement.

As such, by following this structured approach provided by the system herein, it effectively determines and presents the unique selling points to the listing host or user, ensuring that the property is marketed in the most appealing way.

The software operating to generate the listing will generate individual graphic depictions of templates using a set of predefined templates held in electronic memory will provide a basic structure for property descriptions. These templates may include placeholders for dynamic text or visual content to be inserted therein.

The depicted templates on the computing device of the users are designed to cover choices for various property types such as apartments, vacation homes, luxury estates, or other types of property. The templates are also preferably adapted to highlight different types of unique features determined or suggested for inclusion.

Software operating to the task of generating text or copy for the property advertisement, such as AI software similar to ChatGPT or large language model (LLM) software, or other software operating to the task of generating text for advertisements, may be employed to generate custom language and paragraphs for advertisements. Such will emphasize the determined, identified, distinctive characteristics and unique points for inclusion in the listing. For users who are inexperienced or writing-challenged, this step is especially useful. For software operating to the task of generating text, such LLM software may be widely available, such as foundational models like GPT-4, Gemini, and Claude, open-source models such as LLaMA 2 and Mistral, and application-specific models like Code Llama for coding. Or, based on such available LLM software, customized LLM software may be coded for the system herein. Additionally, multiple AI text generation software systems are available, such as for example ChatGPT.

The software operating to generate the text or ad copy will thus generate text for inclusion in the listing, which includes the identified and chosen unique and distinctive characteristics, such as the property having an ocean view, along with a modern kitchen and private pool. The software will operate to insert detailed, engaging descriptions into the relevant placeholders within the template. The inserted text is tailored to highlight the benefits and appeal of each key feature identified or determined, making the listing attractive and informative.

In this fashion, the software-generated content for inclusion in a listing is contextually relevant, meaning the descriptions are crafted to match the overall style and tone of the property listing. For example only, and in no way limiting, the generated text may generate a more elegant and sophisticated description for a luxury villa, while a cozy cottage might have a warm and inviting tone to the generated text.

Once the system has generated what is considered an optimal listing text and graphics, the user of the system may be presented with graphic interfaces of the generated listing for editing and customization. While optional, in this verification step, a final graphic depiction of the system-generated listing draft may be communicated to the computer display of the host user for review. The host user will have the option to edit the computer-generated text, to adjust the emphasis on certain distinctive characteristics, and add their personal touches to the description. The listing is then approved for publication by the system provider.

With the optimal listing generated and then approved subsequent to review, the system may employ software operating to engage in one or more placement steps for matching the listing to various advertising channels, including online platforms, such as, but not limited to, social media may be utilized to disseminate the final listing effectively.

In the step of selecting online property platforms and/or social media platforms for positioning of the property listings, the system may employ software operating with machine learning to analyze a demographic profile of potential buyers or renters and their online behavior. In doing so, the system software will operate to determine where the identified buyer demographic is most active online and which platforms or social media sites are optimal for engagement and positioning of respective listings thereon.

Thereafter, the unique selling points of each property will be employed to match the respective unique features and selling points of each property to the online platforms, which best highlight these aspects.

For example, only and in no way limiting, Instagram may be recommended for properties with visually appealing features such as scenic views or unique architecture, leveraging high-quality images and videos for maximum engagement. The LinkedIn site may be suggested for the listings of properties targeting professionals or corporate clients, based on demographic and professional interests. The Facebook site may be recommended for a broad demographic reach and targeted advertising capabilities suitable for various property types. Finally, YouTube may be recommended as being effective for property listings that benefit from detailed video tours or walkthroughs thereof.

In one placement step, the system may employ software operating to the task of assessing the advertising options of each platform, such as targeted ads and sponsored content thereon. Thereafter, listings for properties best suited for either targeted ads or sponsored content may be suggested for each platform.

In a content strategic placement step, the system may employ software operating to the step of placing property listings upon sites based on the discerned content of each website. Using software running to the task of reviewing and/or machine learning, insights into user interaction behaviors like stories, live videos, or carousel posts, on given websites can be matched to listings that will be of interest to such sites.

In another option for placement, machine learning may be employed for each listing. In this mode of operation, software employing machine learning algorithms may research the various online platforms and then recommend the online platform that best aligns with the property type and its unique selling points.

For example only, the system might recommend using Instagram for a beachfront property, showcasing AI-generated or other sample posts and ad formats that are tailored to highlight scenic views and architectural uniqueness.

Another placement step that may be employed is that of a performance metric matching strategy. In this placement mode, software operating to the task of platform analytics is employed to monitor engagement metrics, click-through rates, and conversions of inquiring buyers. Thereafter, the marketing strategy for listings may be adjusted based on real-time data insights to optimize audience reach and engagement by optimizing the listing to match the monitored metrics of buyers.

With the property published on the system provider website, buyers and renters can search the site for rentals. Upon receiving inquiries or expressions of interest from potential customers for customer input dates, proactive engagement is preferred. This step involves promptly responding to questions, providing additional information upon request, and addressing any concerns or doubts potential customers may have. This step may include one or a plurality of response step interactions.

During the engagement or reservation step to secure a reservation with potential renters or buyers, in one response step, they may be directed by the system provider to send their inquiries or questions directly to the host of the property listing. Upon receiving these inquiries, the host has the option to respond directly. In responding directly, they can choose to answer the questions themselves, or they can leverage recommendations generated by the LLM (Large Language Model). These recommendations are pre-generated responses designed by the system to common questions or inquiries based on the property details and frequently asked questions.

This response step, enabled by the system, provides flexibility to the host in how they manage inquiries. They can use the LLM-generated responses as-is, they can modify the generated responses to better suit the specific needs or nuances of each inquiry, or they may choose to completely answer the inquiry themselves. However, if the host chooses to and/or does not receive any questions, the host and/or personnel can just accept the request to reserve the property.

As such, the engagement process aims to foster a sense of trust and confidence, ultimately increasing the likelihood of successful transactions.

Concurrent with, or subsequent to the engagement step with a customer for a rental, in a particularly preferred step in the process herein, to enhance the changes of securing the reservation by providing extra services, the system will employ software operating to the step of discerning a customer secondary interests during the reservation period, and offering one or a plurality of secondary reservations for local activities.

To discern the secondary interests of the renter or buyer and thereby provide personalized recommendations for local activities, the system employs a combination of direct renter or buyer input and inferred data from the renter or buyer.

In one mode of discerning secondary interests of the renter or buyer during the period of their visit, a hobby questionnaire may be offered as a graphic interface during the account setup for the buyer or renter. The account setup may be required as a first step in the system, or may be required subsequently to the renter or buyer choosing a visit duration for a chosen proper. With the buyer or renter filling in the graphic display presented, it will provide the system with a direct understanding of their preferences.

In addition to securing the renter or customer information concerning their identity and address and any required credit card or payment information, the system may also ask them about their hobbies and interests. These questions may be asked as a first step, as one means for helping to determine the best properties, or as a step subsequent to the user having chosen a property and duration for the rental. To that end, the secondary information concerning hobbies and interests may be sought using a drop-down or by checking the box of interests.

In another step of the system, which may enhance the achievement of rental reservations, the system may employ software to generate an enhanced vacation experience in package deals or bundling. The bundling of the advertised accommodations of the advertised property with local activities and services (vehicles, curated experiences) can add significant value to the system in achieving rental clients for property owners by making it easier for the renters or buyers to arrange everything on the system website. Features like software or AI-driven “Adventure Recommendations” and all-in-one booking capabilities will differentiate the platform and enhance the user experience.

In one step of providing the user with potential vendors or services relating to their interests, software operating to match such vendors held in a database based on the location of the property, will operate to the task of matching discerned user interests relating to those user interests to local vendors who have authorized the system to make reservations. Once matches are discerned, the system will offer the user the ability to secure reservations with the local vendors providing services relating to their interests from the database of vendors for which it is authorized, which is associated with local zip codes or are determined otherwise to be sufficiently proximate to a chosen property.

Other steps the system may take to discern user interests for offering secondary activities may be accomplished using software adapted to the task of image analysis. In this step, software adapted to the task of scanning an input profile image of the user, to discern recognizable activities or settings, can be employed. For example, and in no way limiting, should the profile picture depict the user skiing, the software running to the task of correlating discerned images to interests, and discerning that the user or renter has an interest in skiing. The image scanning software can operate to discern the background of the user's photo for clues, and then correlate the discerned clues to secondary interests of the user.

In another step to help discern secondary interests of the renter or buyer, once they are identified, software operating to search social media such as Facebook can operate to analyze the published bio of the user for keywords and phrases that indicate their interests. In this step, software employing natural language processing (NLP), for example, can be employed to extract relevant information from the user bio. For example only, and in no way limiting, if the bio mentions that the user loves hiking and outdoor adventures, the software operating to match users to secondary activities of the system can infer an interest in hiking and outdoor activities. Thereafter, using a lookup of local providers of such activities who are proximate to the property being rented or sold, the user may be offered the services of those vendors.

In another possible step of offering secondary activities as an enhancement to the reservation process, the system may employ geolocation to determine the current location of the user and/or the location of the property they are renting. This step may be accomplished during the reservation process or subsequent to the user securing the reservation while they are visiting the property. This helps in providing recommendations and reservations for vendors of nearby activities and attractions.

For example only, and in no way limiting, if the property is near a ski resort, the system employing software operating to review local activities proximate to the property location may suggest that skiing might be of interest to the user. Using software running to the task of taking provided preferences and correlating them to local providers of services and such held in the database of providers, the system can then provide the user with customized recommendations for secondary activities such as, and in no way limiting, hikes, restaurants, scuba, surfing, and thereby provided enhanced services which will also help secure the rental or sale of the property.

In all modes of the system and steps herein noted, the property listing enhancement system herein, the system provider will employ network accessible servers or computers having accessible electronic memory for storage and retrieval of electronic database information relating to each individual property listing characteristic along with an identification and offering of other vacation activities which are geographically proximate to the identified property, and related data needed correlating to the stated task or step or requirement of the operation noted to be performed by the software. Software running in electronic memory will operate to allow property listing users to input data or information required for the enhanced property listings, as well as to aid buyers or renters to identify properties of interest based on their input parameters for such, and to additionally provide buyers or renters with associated local activities and venues based on their interests.

As to electronic memory or computer-readable media for the system herein, any combination of one or more computer-usable or computer-readable media, be it transitory or non-transitory, may be employed for operation of the software and assessment system herein. Such, for example and in no way limiting, can include computer-readable media and may include one or more of a portable computer diskette, a hard disk, a random access memory device, a read-only memory device, an erasable programmable read-only memory (EPROM or Flash memory) device, a portable compact disc read-only memory device, an optical storage device, and other electronic memory magnetic storage devices. Software or computer program code for carrying out the individual and sequential operations and property description and secondary activity identification of the present invention may be written in any combination of one or more programming languages.

The steps or method of operation and/or execution of the various modes and tasks of the system herein may be illustrated as blocks or steps in the drawings, which may represent one or more sequences in the operation of the steps and assessments in the system herein. These operations or steps can be implemented in hardware, software operating to process input data to accomplish the task or step, or a combination thereof.

With regard to software operating to a task or steps or assessments indicated in the system herein, such represents computer-executable instructions stored upon one or more transitory or non-transitory computer-readable storage media, which, when executed by one or a plurality of processors, will operate to perform the recited task, assessment, operation, or step. Computer-executable instructions, in general, include routines, programs, algorithms, data structures, and the like, which are configured to perform particular functions or to implement particular abstract data types or steps noted.

It should be noted that the sequence in which the steps of the system herein are described or depicted for property listings and optimization thereof, as well as property identification with associated local venues and highlights, is not intended to be construed as a limitation. It should be understood that any number of the described or designated steps can be combined in any order and/or in parallel to implement the described and depicted assessments and processes. In some modes of the system herein, one or more steps can be rearranged or omitted entirely. Still further, the software-enabled steps in the system herein can be combined in whole or in part with each other or with other steps or methods.

With respect to the above description, before explaining at least one preferred embodiment of the system and method of optimizing property listings for sellers and providing enhanced property identification and local options to buyers or renters, it is to be understood that the invention is not limited in its application to the details of operation nor the arrangement of the components or the steps set forth in the following description or illustrations in the drawings. The various methods of implementation and operation of the system and method herein are capable of other embodiments and of being practiced and carried out in various ways, which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other software enabled methods and systems for property listing enhancement and for property identification for buyers and renters which is associated with enhanced local options for renters and buyers, and for carrying out the several purposes of the present method. Therefore, the objects and claims herein should be regarded as including such equivalent construction, steps, and methodology insofar as they do not depart from the spirit and scope of the present invention.

It is an object of this invention to provide a computer-implemented method employing software operating to the task of identifying and highlighting distinctive property features in property advertisements for property owners subscribing to the system.

It is a further object of this invention to provide a personalized rental property or property for sale to buyers, which includes identified properties of interest in combination with a bundling of local activities and rental vehicles, and the like.

It is yet another object of this invention to provide such a personalized property rental and sales system, which will discern local activities available for the visit dates of the buyer and bundle any chosen activities for the buyer with the rental of the property.

It is yet another object of this invention to assemble a database of local activities geographically local to rental properties listed on the system, and to provide an interface for both reservations for activity providers for scheduling reservations, as well as for providing payments therefor.

It is a further object of this invention to provide all-inclusive bundling of rental properties for vacations and visits to buyers with buyer-desired attractions and reservations therefor in an all-inclusive package with billing and reservations accomplished at the same time.

These, together with other objects and advantages, which become subsequently apparent, reside in the details of the construction and operation of the property listing enhancement and secondary activity identification system herein as more fully hereinafter described and claimed, reference being had to the accompanying drawings forming a part thereof, wherein like numerals refer to like parts throughout.

Further objectives of this invention will be ascertained by those skilled in the art, as brought out in the following part of the specification, wherein a detailed description is for the purpose of fully disclosing the invention without placing limitations thereon.

### BRIEF DESCRIPTION OF DRAWING FIGURE

FIG. 1 depicts a simplified flow chart of the system herein operating to determined identified unique points for inclusion in the listing and employ software operating to emphasize them.

FIG. 2 step of selecting online property platforms for advertisement of the respective properties.

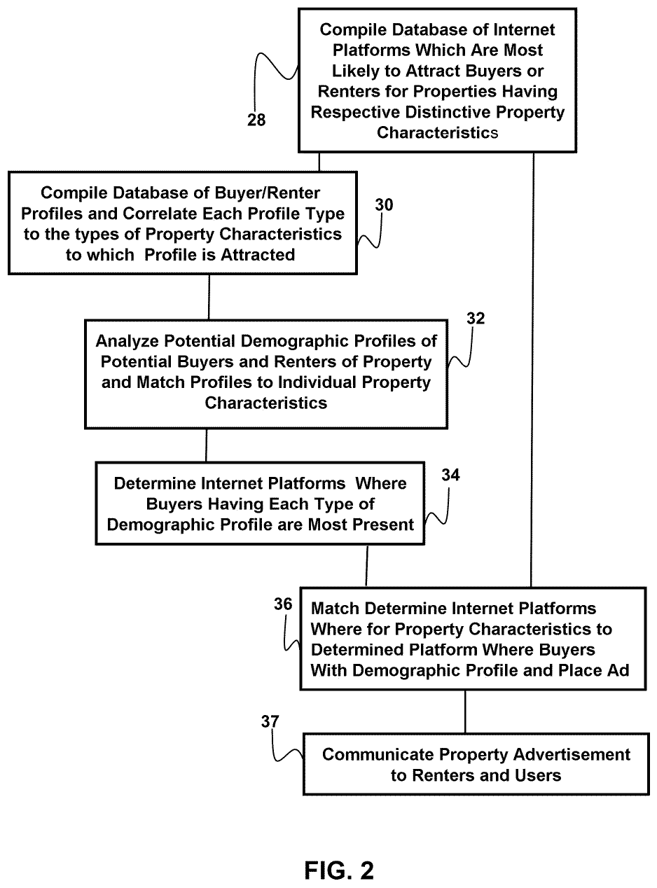

FIG. 3 depicts an enhanced mode of the system herein, wherein the renter is offered reservations for local attractions and activities for which the system is authorized to take reservations.

### DETAILED DESCRIPTION OF THE PREFERRED EMBODIMENTS OF THE INVENTION

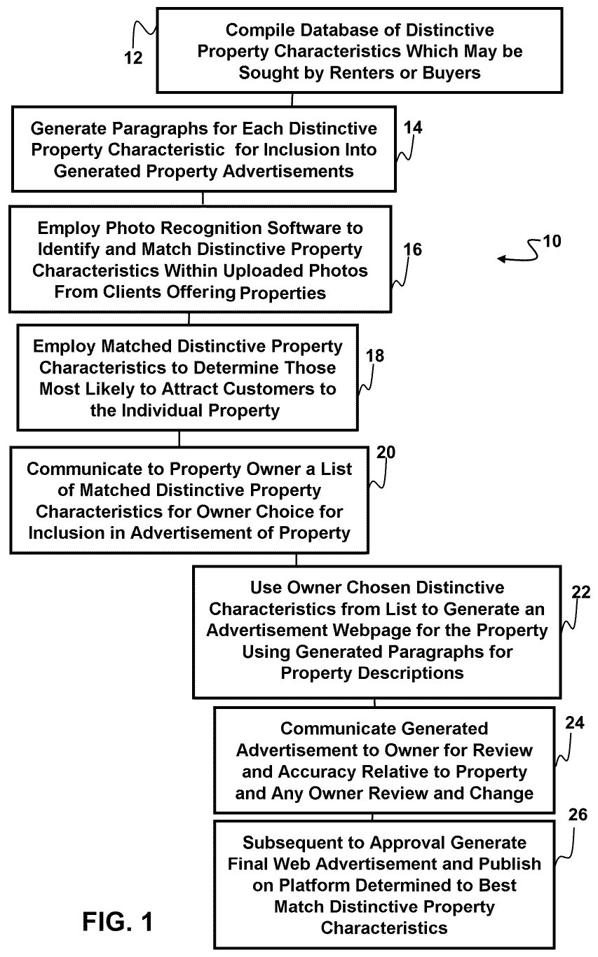

Referring now to the method and system 10 herein shown in simple format by the depictions of FIG. 1, as noted above, software running in electronic memory coupled to a computer or server or other computer processor to perform each step or task in the system 10 herein, may operate in electronic memory on network-connected computers having such software operatively running thereon, wherein property rental and sale listings can be crafted in an optimized fashion for both the property owner and the renter or buyer by the system 10 over a network, such as the internet.

The system 10 herein operates with a plurality of preferred software=enabled operations employing software operating to the tasks of, intake of a property listing from an owner seeking to rent or sell, including identification of distinctive characteristics of the property in property advertisements which are determined using image recognition software and/or menu inputs for the property owner, automated listing advertisement generation using LLM software to generate detailed and compelling property descriptions, a determination of recommended advertising channels for a property, and once the property is listed and advertised, providing enhanced vacation packages which include activities and attractions which are local or proximate to the location of the listed property to renters or vacationers. Such, for example only, may be ski slopes, amusement parks, wineries, museums, and other activities and attractions as would occur to those skilled in the art.

In operation of the system 10 herein, the system provider may compile a database of property characteristics and distinctive characteristics that are determined as such that may be sought by potential buyers 12. This may be an ongoing process wherein software operating to continually compile known and newly discerned desirable property characteristics will maintain a database thereof.

Software operating to the task of composing write-ups or text which emphasize such characteristic 16, which may be in a database thereof, will operate to generate descriptive paragraphs which may be associated with each distinctive property characteristic. The descriptive paragraphs may be held in a database thereof and related to the compiled property characteristics. In this fashion, when a new or existing property is to be described for an advertisement, the distinctive characteristics may be ascertained, and then the descriptive paragraphs may be employed in composing advertising for the property.

The database of known characteristics 14 may also include characteristic digital images or sections thereof which are recognizable as corresponding to one of the distinctive characteristics. In this fashion, the photo recognition software may employ such characteristic digital images to match the same distinctive characteristics in newly uploaded or input digital images of new properties to be listed.

In one mode of the system 10, a property owner will submit their property for review and listing, and then the photo recognition software may be employed to inspect each digital image or photograph of a property being submitted by an owner. The software will operate to the task of digitally inspecting the pixels of each digital image or photograph to ascertain one or more of the distinctive characteristics 16 which match those in the distinctive characteristic database 12, which are determined to be present in the images and photos of the property being submitted by a property owner and being examined.

For each new property to be listed and have graphic advertisements composed therefor, software operating to the task of examining photos and images of the submitted property and matching the determined identified distinctive characteristics in the digital images or digital photos 18, to those characteristics determined as most likely to attract customers since they match those of the database as characteristics sought by renters or buyers 12. As noted above, the identified distinctive characteristics held in the database of such for renters and buyers 12 may be ranked according to the value of each for attracting renters or buyers. This allows the system to place or generate property advertisements that include distinctive characteristics with the most value, more prominently.

At this juncture, the system may employ software operating to the task of drafting an online advertisement using the distinctive characteristics 16 identified, and then generating a final web advertisement 26. For many property owners, skipping the steps between may be preferred where they do not wish to provide input on the distinctive characteristics or generated text and advertisements.

Where a property owner is desirous of input, a listing of matched distinctive characteristics discerned in the digital photos which may be ranked or matched to the known characteristics sought by renters 12, may be communicated to the owner to allow the owner a choice for which matched characteristics would be included in an advertisement 20 using the computer software generated text and paragraphs 14 for such.

Upon review by the owner desiring such, a graphic display of distinctive characteristics may be presented to the owner for the owner to choose which distinctive characteristics to include, which may be sent from the owner to the system provider 22. This communication may be as simple as the owner checking a box on a graphic interface to include all software-identified characteristics, or it may be provided using an owner affirmation to use one or more of the items in the distinctive characteristics list to help generate an advertisement.

Where applicable using the owner-affirmed list of identified distinctive characteristics of the property to use in generating an advertisement 22, the system will then employ the software generated text and copy paragraphs which include each distinctive characteristic 14, identified and/or approved, to generate a written advertisement which may be communicated to the owner 24 for review and changes if any or may simply be published online.

Subsequent to an approval of the owner, either by a simple check-the-box affirmation, or other menu-driven communications for approval, software operating to draft a web advertisement using the paragraphs matching each distinctive characteristic 14 will operate to generate a final web advertisement 26.

With the final web advertisement generated 26, the system will operate to recommend advertising channels on the internet, such as websites and social media sites, where the identified unique characteristics of the property are most likely to attract buyers or renters. With such determined software operating to the task will publish the advertisement to one or more web platforms that are determined best for both the distinctive property characteristics and where buyers attracted to such characteristics are likely to visit.

Toward this operation of the system, software operating to the task may compile a database of individual internet platforms or sites, which based on the included property characteristics in the published advertisement, are most likely to attract property buyers or renters to property having those determined distinctive property characteristics. This Internet platform database may be maintained on an ongoing basis to continually update those internet platforms that currently attract buyers for the particular different property characteristics, since such changes over time and new platforms are constantly being published.

Concurrently, the system may employ software operating to the task of determining the profiles of buyers or renters who are attracted to the identified property characteristics 30 in the generated advertisement. Additionally, the system may employ software operating to the task of analyzing the demographic profiles of potential buyers and renters to match the buyer profiles so determined, to an affinity for individual property characteristics 32. This may be done through questions, answers, and input from the buyer or renter seeking a property.

Using the database of platforms where buyers visit based on being attracted to particular distinctive characteristics 28 a match may be determined with internet and social media platforms where buyers having each type of demographic profile which match those attracted to the same property characteristics, the platform or platforms may be determined 36 for software of the system to operate to place the Webpage or advertisement generated and published subsequent to owner approval 26.

In this fashion, using the advertisements optimized to best publicize the property characteristics that attract buyers and renters, placed upon platforms determined as best or a match to those visited by buyers or renters attracted to these characteristics, the highest probable success rate for renting and selling each individual property having its own unique property characteristics is provided.

With the ad placed 36, the system employing software operating to the task, will communicate webpages and video depictions of the property advertisement to customers, allowing them to book the advertised property 37. This booking step employs software operating to the various tasks, may check available dates, suggest alternate dates, and allow the user or renter to make the reservation for the advertised property, which will be communicated to the property owner. The system may also employ software to receive payment from the user at the time of the reservation, or allow the property owner to collect payment.

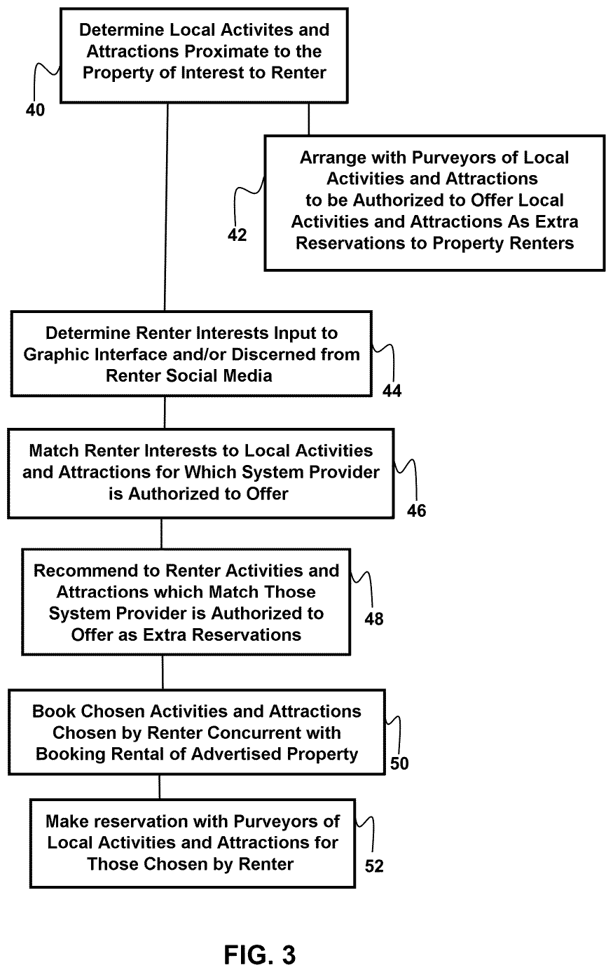

As noted, an enhanced mode of the system 10 herein is shown in FIG. 3, where concurrent with the booking of reservations for an advertised property 37, an enhanced operation offers reservations for local attractions and activities for which the system is authorized to take reservations.

As shown, the system 10 will determine local activities and attractions which are proximate to each respective property being offered by the system to renters or buyers 40. This, as noted, may be accomplished using zip codes and local listings, or Google Maps or other searchable means to determine local vendors for such.

In order to be able to offer such activities and attractions, the system provider will arrange with purveyors of such to be authorized to take reservations for them 42. Such may require the system 10 to interface with the calendaring system of the providers of such activities and attractions.

In this enhanced mode of the system 10, renter interests relating to such activities and attractions will be determined 44. This may be accomplished by communicating a graphic interface to the renter, listing various interests that they may choose. It may also be accomplished using software operating to the task of surveying the social media sites of the renter, such as Facebook, to discern from text and photos thereon, the interests of the renter.

Software operating to the task will match the determined renter interests to local activities and attractions for which the system 10 is authorized 46. The system may also query the calendaring system of each for availability. Then, the software operating to the task will recommend the activities and attractions matched to the renter, which show availability and offer such for making reservations 48. This may be accomplished with a graphic interface communicated to the renter or user showing the different activities and attractions, and giving the user inputs such as drop-down menus or check boxes to allow them to choose one or a plurality of activities and attractions and book them 50.

Finally, concurrent with making the property reservation 37, the system 10 employing software operating to the task, will make reservations with the chosen providers of the suggested activities and attractions which were deemed available on the dates for the rental of the property.

While all of the fundamental characteristics and features of the property listing and enhancement system herein have been shown and described herein, with reference to particular embodiments thereof, a latitude of modification, various changes and substitutions are intended in the foregoing disclosure and it will be apparent that in some instances, some features or steps

of the disclosed system may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations, and substitutions are included within the scope of the invention herein disclosed.

What is claimed is:

1. A system for optimization for property listings and optimization of renter purchasing thereof, comprising:
a processor, and
a non-transitory, computer readable medium communicably coupled to the processor and storing instructions that, when executed by the processor, cause the processor to perform operations comprising:
having a property owner submit a property for rental and submit digital images relating to the property;
inspecting digital images associated with the property to find determined distinctive characteristics;
composing software-generated write-ups for a property advertisement which include said determined distinctive characteristics of said property;
generating text for an online advertisement for the property wherein said text includes descriptions of said distinctive characteristics of said property; and
providing renters for said property a graphic interface to make reservations for said property.

2. The system for optimization for property listings and optimization of renter purchasing thereof of claim 1 additionally comprising:
compiling a database of renter-sought distinctive property characteristics;
including captured digital images of said renter-sought distinctive property characteristics; and
inspecting digital images of the property to find determined distinctive characteristics by matching sections of said digital images with said captured digital images to determine said determined distinctive characteristics of said property.

3. The system for optimization for property listings and optimization of renter purchasing thereof of claim 1 additionally comprising:
generating a database of text paragraphs associated with each of said determined distinctive characteristics; and
including all or portions of said text paragraphs in said text for said online advertisement for the property.

4. The system for optimization for property listings and optimization of renter purchasing thereof of claim 2 additionally comprising:
generating a database of text paragraphs associated with each of said determined distinctive characteristics; and
including all or portions of said text paragraphs in said text for said online advertisement for the property.

5. The system for optimization for property listings and optimization of renter purchasing thereof of claim 4 additionally comprising:
communicating to said property owner, a list of said determined distinctive characteristics to be chosen by said property owner; and
including said determined distinctive characteristics chosen by said owner in said online advertisement for said property.

6. The system for optimization for property listings and optimization of renter purchasing thereof of claim 1 additionally comprising:
determining an internet platform visited by individuals attracted to said determined distinctive characteristics; and
publishing said online advertisement for the property for viewing by said individuals visiting said internet platform.

7. The system for optimization for property listings and optimization of renter purchasing thereof of claim 2 additionally comprising:
determining an internet platform visited by individuals attracted to said determined distinctive characteristics; and
publishing said online advertisement for the property for viewing by said individuals visiting said internet platform.

8. The system for optimization for property listings and optimization of renter purchasing thereof of claim 3 additionally comprising:
determining an internet platform visited by individuals attracted to said determined distinctive characteristics; and
publishing said online advertisement for the property for viewing by said individuals visiting said internet platform.

9. The system for optimization for property listings and optimization of renter purchasing thereof of claim 4 additionally comprising:
determining an internet platform visited by individuals attracted to said determined distinctive characteristics; and
publishing said online advertisement for the property for viewing by said individuals visiting said internet platform.

10. The system for optimization for property listings and optimization of renter purchasing thereof of claim 5 additionally comprising:
determining an internet platform visited by individuals attracted to said determined distinctive characteristics; and
publishing said online advertisement for the property for viewing by said individuals visiting said internet platform.

11. The system for optimization for property listings and optimization of renter purchasing thereof of claim 1 additionally comprising:
determining activities and attractions which are geographically proximate to a location of said property;
arranging to offer said activities and attractions to said renters for said property on dates of a visit of said renter to said property;
including reservation choices for said activities and attractions on said dates of visit in said graphic interface to make reservations for said property.

12. The system for optimization for property listings and optimization of renter purchasing thereof of claim 2 additionally comprising:
determining activities and attractions which are geographically proximate to a location of said property;
arranging to offer said activities and attractions to said renters for said property on dates of a visit of said renter to said property;
including reservation choices for said activities and attractions on said dates of visit in said graphic interface to make reservations for said property.

13. The system for optimization for property listings and optimization of renter purchasing thereof of claim 8 additionally comprising:
determining activities and attractions which are geographically proximate to a location of said property;
arranging to offer said activities and attractions to said renters for said property on dates of a visit of said renter to said property;
including reservation choices for said activities and attractions on said dates of visit in said graphic interface to make reservations for said property.

14. The system for optimization for property listings and optimization of renter purchasing thereof of claim 9 additionally comprising:
determining activities and attractions which are geographically proximate to a location of said property;
arranging to offer said activities and attractions to said renters for said property on dates of a visit of said renter to said property;
including reservation choices for said activities and attractions on said dates of visit in said graphic interface to make reservations for said property.

15. The system for optimization for property listings and optimization of renter purchasing thereof of claim 10 additionally comprising:
determining activities and attractions which are geographically proximate to a location of said property;
arranging to offer said activities and attractions to said renters for said property on dates of a visit of said renter to said property;
including reservation choices for said activities and attractions on said dates of visit in said graphic interface to make reservations for said property.

16. The system for optimization for property listings and optimization of renter purchasing thereof of claim 1 additionally comprising:
ranking each of said determined distinctive characteristics with a value; and
generating text for an online advertisement for the property with said determined distinctive characteristics having a highest value more prominently in said text.

17. The system for optimization for property listings and optimization of renter purchasing thereof of claim 10 additionally comprising:
ranking each of said determined distinctive characteristics with a value; and
generating text for an online advertisement for the property with said determined distinctive characteristics having a highest value more prominently in said text.
